(19) United States
(12) Patent Application Publication
(10) Pub. No.: US 2003/0127482 A1
(43) Pub. Date: Jul. 10, 2003

(54) Storage system for a vehicle

(76) Inventor: Dale A. Gort, Holland, MI (US)

Correspondence Address: FOLEY & LARDNER, 777 EAST WISCONSIN AVENUE, SUITE 3800, MILWAUKEE, WI, 53202-5308, US

(21) Appl. No.: 10/041,654

(22) Filed: Jan. 4, 2002

(51) Int. Cl. B60R 7/00; B60R 9/00; B60R 11/00

(52) U.S. Cl. 224/549; 224/553; 224/554; 224/564

(57) ABSTRACT

A storage system is disclosed for a vehicle and includes one or more support members adapted to couple to the vehicle, a cargo storage platform coupled to the support members, and an adjustment device operably engaging the support members and the cargo storage platform to configure the cargo storage platform in one or more positions.

A cargo management system for a vehicle is also disclosed and includes means for coupling at least one support column to the interior of the vehicle, means for coupling a cargo holder to the support column; and means for alternatively positioning the cargo holder in a usage position and a stowed position.

### FIELD OF THE INVENTION

The present invention relates to a storage system, and more particularly relates to a system for storing cargo within a vehicle.

### CROSS REFERENCE TO RELATED APPLICATIONS

The following patents and/or patent applications are hereby incorporated by reference: U.S. Pat. No. 6,015,071 titled “Vehicle Storage Divider” issued Jan. 18, 2000; U.S. Pat. No. 6,050,202 titled “Storage Divider Shelf” issued Apr. 18, 2001; U.S. Pat. No. 6,199,948 titled “Interchangeable Module System” issued Mar. 13, 2001; U.S. patent application Ser. No. ______ titled “Load Floor System” filed on Dec. 7, 2001(Attorney Docket No. 026032-3872); U.S. patent application Ser. No. 09/846,811 titled “Modular System For A Vehicle” filed May 1, 2001 (Attorney Docket No. 026032-3676); and U.S. patent application Ser. No. ______ titled “Article Attachment System” filed Jan. 4, 2002 (Attorney Docket No. 026032-3849).

### BACKGROUND OF THE INVENTION

Modular storage compartments in the forward portion of vehicles are generally known and include consoles and structures for mounting items such as lamps, small storage compartments and electronic instrumentation such as compasses, temperature displays and clocks. Such modular systems typically have mounting configurations that permanently attach such articles to a structural portion of the vehicle, whereby installation of article options are typically conducted in a factory setting during vehicle construction and often requires user-selection of the desired articles prior to vehicle assembly, or user acceptance of preinstalled option packages. Such articles or components are typically attached directly to a particular position on the vehicle structure and often are not interchangeable and are not suitable for receiving a wide variety of other articles or components useful in a vehicle. Other generally known storage systems for vehicles include shelves, wells or compartments that typically are integrally formed with, or permanently attached to, an interior structure of a vehicle for storing or transporting cargo. Such known cargo storage devices generally limit the options for customizing the manner in which cargo is stored, and may require cargo to stored only in pre-designated locations due to size and other compatibility requirements. Such known storage devices, when unused, may also occupy valuable interior space within a vehicle that might otherwise be used more efficiently for other purposes.

Accordingly, it would be advantageous to provide a storage system that may be mounted at various locations within a vehicle. It would also be advantageous to provide a storage system having a variety of adjustable receiving configurations for adapting to a variety of cargo items for use or transport within a vehicle. It would be further advantageous to provide a storage system that is rapidly and easily deployable between a usage configuration when need for storing or transporting items, and a stowed configuration to increase available interior space when cargo storage or transportation capability is not required. It would be further advantageous to provide a storage system that is easily installed or removable from a vehicle to optimize cargo management flexibility within the interior space of a vehicle.

Accordingly, it would be advantageous to provide a storage system for a vehicle having any one or more of these or other advantageous features.

### SUMMARY OF THE INVENTION

The invention relates to a storage system for a vehicle and includes at least one support member adapted to couple to the vehicle, a cargo device coupled to the support member, and an adjustment device operably engaging the support member and the cargo device to configure the cargo device in at least one position.

The invention also relates to a cargo management system for a vehicle and includes means for coupling at least one support column to the interior of the vehicle, means for coupling a cargo holder to the support column, and means for alternatively positioning the cargo holder in a usage position and a stowed position.

The invention further relates to a kit for a storage system in a vehicle, an includes at least one support member adapted to be coupled to the vehicle, a cargo holder adapted to be coupled to the support member, and a locking device adapted to releasably lock the cargo holder in a cargo storage position relative to the support member.

### BRIEF DESCRIPTION OF THE DRAWINGS

FIG. 1A is a perspective view from a first side of a storage system for a vehicle according to a preferred embodiment.

FIG. 1B is a perspective view from a second side of a storage system for a vehicle according to a preferred embodiment.

FIG. 2A is a side view of a storage system for a vehicle in a usage position according to a preferred embodiment.

FIG. 2B is a cut away view of a storage system for a vehicle in a release position according to a preferred embodiment.

FIG. 2C is a cut away view of a storage system for a vehicle in a stowed position according to a preferred embodiment.

FIG. 3 is a perspective view from a first side of a storage system for a vehicle according to a preferred embodiment.

FIG. 4A is a cut away view of a storage system for a vehicle in a usage position according to a preferred embodiment.

FIG. 4B is a cut way view of a storage system for a vehicle in a released position according to a preferred embodiment.

FIG. 5A is a cut away view of a storage system for a vehicle in a usage position according to a preferred embodiment.

FIG. 5B is a cut away view of a storage system for a vehicle in a released position according to a preferred embodiment.

FIG. 6 is a cross sectional view along line 6-6 of FIG. 4B according to a preferred embodiment.

### DETAILED DESCRIPTION OF THE PREFERRED EMBODIMENTS

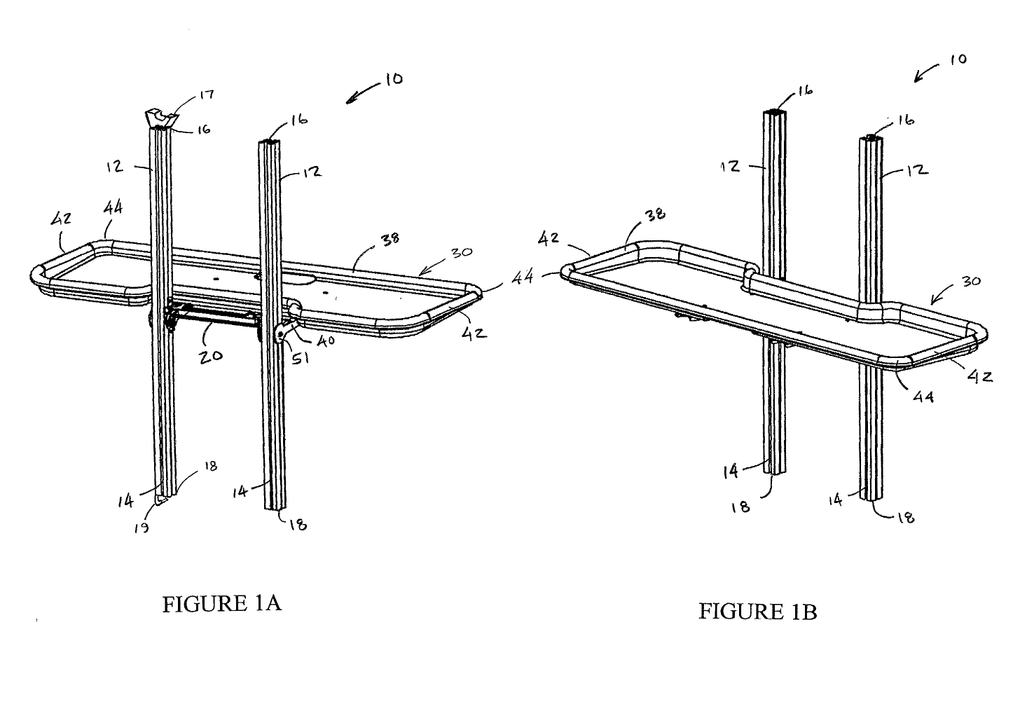

Referring to FIGS. 1A and 1B, a storage system 10 is shown schematically for holding articles (exemplary articles will be further described herein). In a preferred embodiment, system 10 is adapted to hold, store, carry, display and transport one or more articles of cargo within an interior portion of a vehicle, but may be used in other applications suited for holding or storing articles. In a particularly preferred embodiment, system 10 is preferably sized to have a load carrying capacity of up to one-hundred (100) pounds at ten (10) G's of acceleration to ensure structural integrity under normal and abnormal vehicle dynamic conditions, but may be designed to handle other load capacities as necessary to accommodate particularly desired uses. One or more elongated support members 12 (e.g. columns, pillars, posts, etc.) are provided and may have longitudinal ribs, tracks, or rails 14 formed therein. In a particularly preferred embodiment, support members 12 are oriented substantially vertically and include a telescoping portion that is selectively extendable and retractable to accommodate various vehicle interior cargo storage space heights, and may be biased in an outward (i.e. fully extended) position by one or more internal springs (not shown). The telescoping portion may be retained in a selected position by any conventional retainer device such as springloaded pins that engage one of a plurality of spaced apertures (not shown), or conventional threaded-collars such as those used on adjustable tripod legs for cameras, video equipment or other devices (not shown).

Referring further to FIGS. 1A and 1B, support members 12 preferably include attachment devices such as a quick-release connector at a top end 16 and a bottom end 18. In a particularly preferred embodiment, the connector 17 (shown schematically on a single support member in FIG. 1A) at the top end 16 is an attachment device as described in U.S. patent application Ser. No. ______ titled Article Attachment System, filed on Jan. 4, 2002 (Attorney Docket 026032-3849) and incorporated by reference herein. Top end 16 preferable includes a projecting plate portion (not shown) that releasably latches within connector 17. The connector 17 is preferably adapted to engage a structure within the vehicle such as a bracket (not shown) or a rail member (not shown) provided along an interior portion (e.g. headliner, side panel, floor portion, etc.) of the vehicle such as that described in U.S. patent application Ser. No. 09/846,811 titled “Modular System for a Vehicle” filed May 1, 2001, which is incorporated by reference herein, but may be adapted to engage any suitable structure in the overhead or other portions of the vehicle interior. In alternative embodiments, the support members may be connected to a portion of a vehicle seat, and may be oriented at a vertical angle corresponding to the angle of the seat back (not shown). The connector 19 (shown schematically on a single support member in FIG. 1A) at bottom end 18 is preferably adapted to engage brackets (not shown) in the vehicle floor, such as brackets for retaining removable seats, however, support members 12 may be removably attached to the floor in any convenient manner in alternative embodiments. Support members 12 are preferably made of aluminum but may be plastic or any other lightweight material having suitable strength and durability to support articles of cargo.

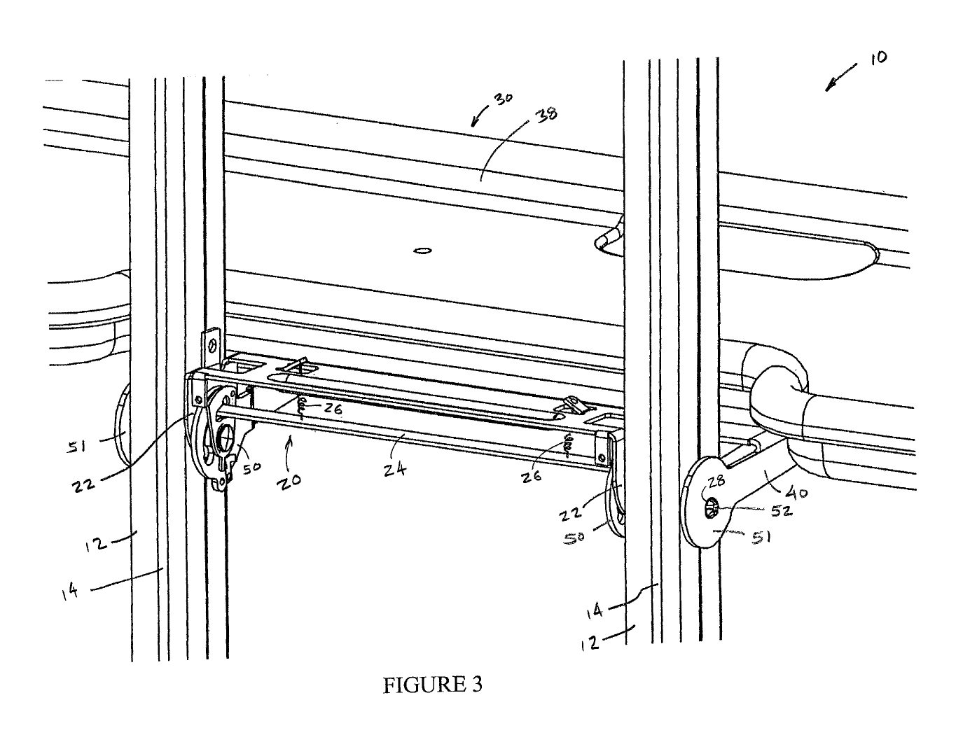

Referring to FIG. 3, a positioner interface is shown according to a particularly preferred embodiment. Positioner interface 20 having end flanges 22 is coupled to support members 12 by couplers 28 (e.g. clamps, detents, spring-biased pins, fasteners, etc. and shown as pins) or other suitable coupling devices adapted to allow flanges 22 to be selectively adjusted axially along support members 12 in a plurality of predetermined positions provided with receiving holes or other suitable structure (not shown), and includes a locking member 24 (e.g. follower, link, bar, etc. shown more particularly in FIG. 3). Locking member 24 is provided between support members 12 and is restrained in a horizontal direction by end flanges 22, but is capable of limited travel in a vertical direction, and is preferably biased by spring 26 in a vertically upward direction. In an alternative embodiment, the positioner interface may have an adjustable width to accommodate various lateral spacing options for the support members.

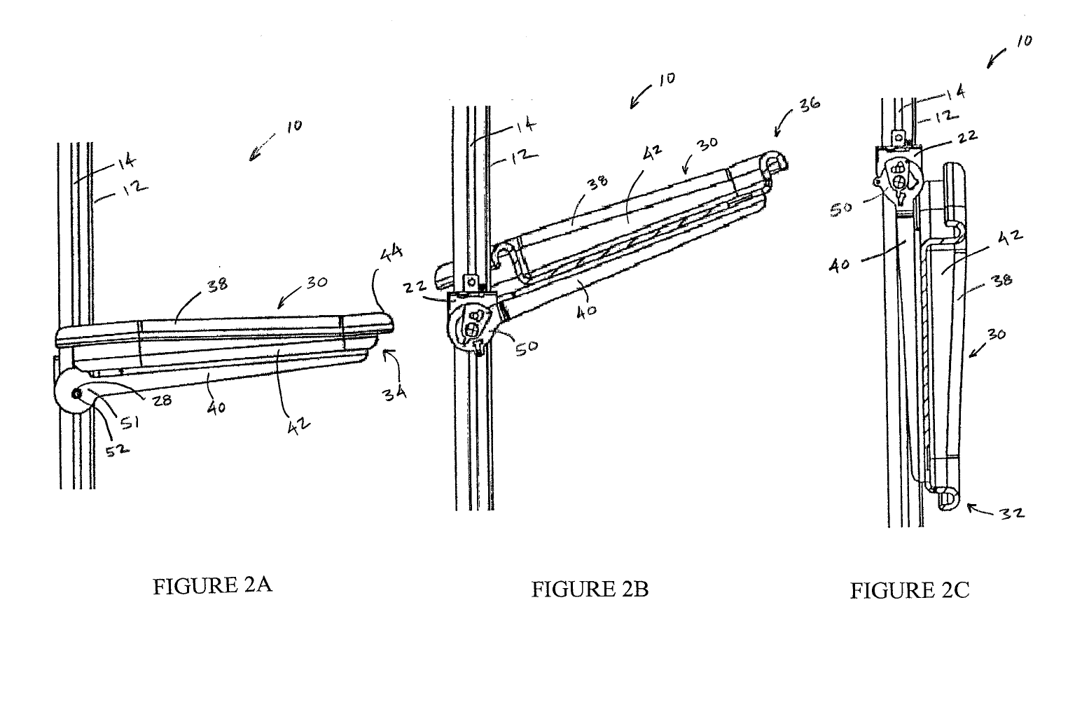

Referring to FIGS. 2A and 2B, a cargo holder of the storage system is shown according to a preferred embodiment of the present invention. Cargo holder 30 (e.g. storage device, platform, shelf, tray, etc.) is provided in a sliding relationship with support members 12 for vertical height adjustment in any one of a plurality of predetermined positions, and a pivoting relationship with support members 12 for movement between a stowed position 32 where the cargo holder 30 is folded downward to a generally vertical position to provide other storage options within the vehicle, and a raised generally horizontal usage position 34 for holding various articles of cargo. Cargo holder 30 may be provided with a peripheral lip, ledge, or wall 38 to improve cargo retention, and may further include cargo management devices such as recesses, hooks, cords, straps, tie-downs, netting, dividers, handles, folding partitions or other cargo management options (not shown) as provided in one or more of U.S. Pat. No. 6,015,071 titled “Vehicle Storage Divider” issued Jan. 18, 2000, U.S. Pat. No. 6,050,202 titled “Storage Divider Shelf” issued Apr. 18, 2001, or U.S. Pat. No. 6,199,948 titled “Interchangeable Module System” issued Mar. 13, 2001, the disclosures of which are incorporated by reference herein. In a particularly preferred embodiment, cargo holder 30 is made of a glass reinforced polymer in a molding process and may be formed having a solid base, or a perforated, mesh or honeycomb-formed base for weight reduction and improved reception of straps and hooks and may be provided in a variety of colors coordinated with available vehicle interior color schemes. In alternative embodiments, the cargo holder may by made of rubber-coated or plastic-coated, or uncoated, wire mesh or rods, similar to conventional shelving, baskets, racks or carts. In other alternative embodiments, the cargo holder may be made of sheet metal or aluminum in a stamping or other suitable process, or other lightweight materials having suitable strength and durability to support articles of cargo.

Referring further to FIGS. 2A-2C, one or more arm members 40 are provided on an underside of the cargo holder 30 and pivotally coupled to support members 12 to support cargo holder 30 in usage position 34. Arm members 40 may be oriented generally parallel to the sides 42 of cargo holder 30, or may be positioned at an angle and extend toward front corners 44 of cargo holder 30 to improve the flexural stability of cargo holder 30. Arm members 40 are preferably fastened to an underside of cargo holder 30 by fasteners or integrally molded with cargo holder 30, but may be attached using any suitable method. Arm members 40 include a hub member having an inner hub portion 50 and an outer hub portion 51 with a centrally located pivot point 52 axially aligned with coupler 28 for pivoting cargo holder 30 between the stowed position 32, the release position 36 and the usage position 34.

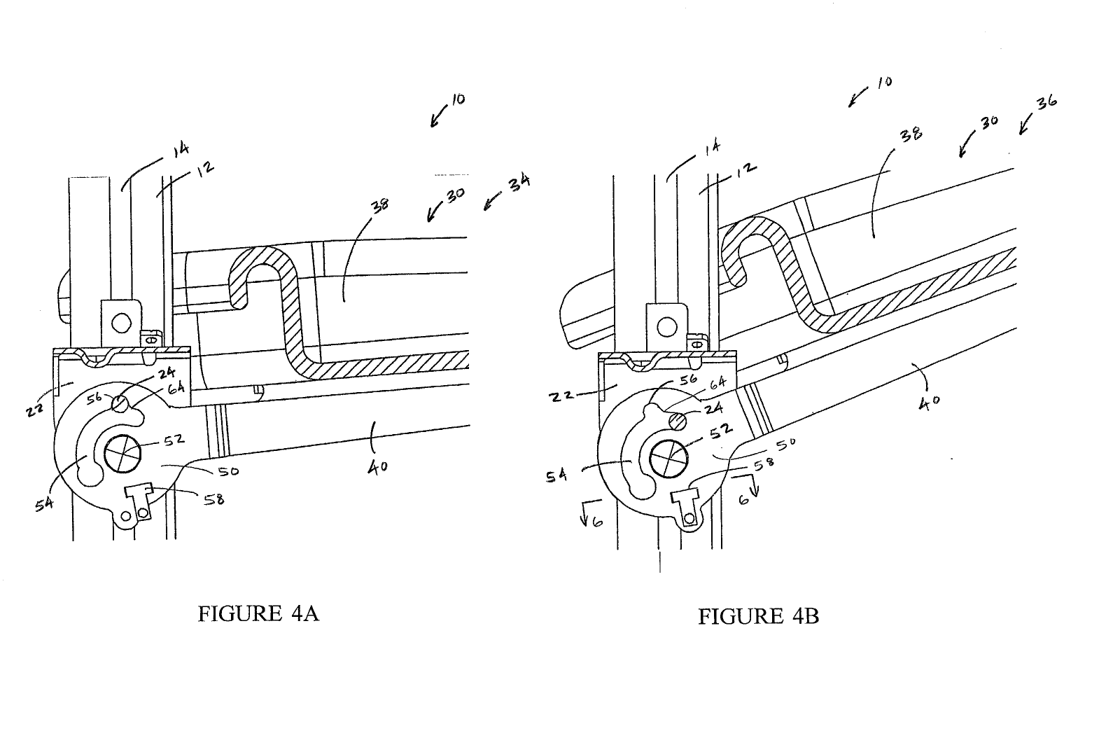

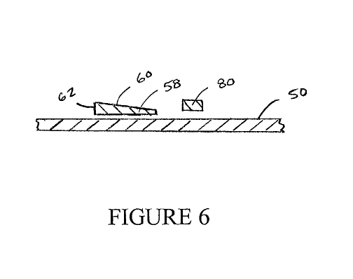

Referring to FIGS. 4A-4B, An adjustment device for positioning the cargo holder in one or more positions is shown according to a preferred embodiment (shown without release actuator 70, to be further described, for clarity). Inner hub portions 50 on an inner side of support members 12 include a generally arcuate slot 54 formed therein having a locking recess 56, and a tab 58 attached to an inner face of hub member 30. Tab 58 preferably has a ramp or wedge shape (shown schematically in FIG. 6) with a slide portion 60 and a face portion 62. Locking member 24 extends through slot 54 on each inner hub 30 and travels along slot 54 as cargo holder 30 is moved between usage position 34 and stowed position 32. As cargo holder 30 approaches the horizontal usage position 34, spring-biased locking member 24 is biased into locking recess 56, thereby supporting cargo holder 30 in the usage position 34.

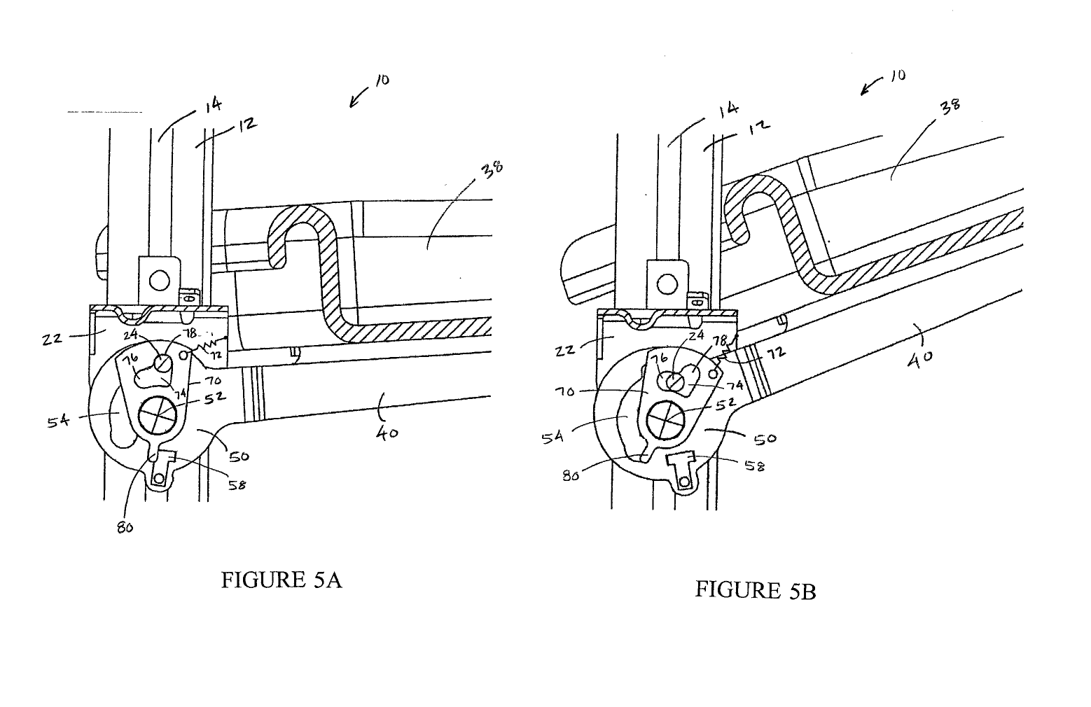

Referring to FIGS. 5A-5B, a release actuator for the storage system is shown according to a preferred embodiment. Release actuator 70 is provided having a common pivot axis with pivot point 52 and is oriented in a pivotally slidable, facing relationship with hub 30. In a particularly preferred embodiment, two release actuators are provided, one release actuator associated with each of inner hubs 30. Release actuator 70 is biased by spring 72 and includes an L-shaped slot 74, having a lower leg 76 in alignment with hub arcuate slot 54 and an upper leg 78 aligned with hub locking recess 56. Release actuator 70 preferably includes a tang or projection 80 at a lower end that is located to rotationally interface with tab 58.

Referring further to FIGS. 4A, 4B, 5A and 5B, the operation of the adjustment device is shown according to a preferred embodiment. In operation, cargo holder 30 is released from usage position 34 by lifting the front end of cargo holder 30 upward to release position 36 so that a cam portion 64 of slot 54 moves locking member 24 downward from locking recess 56. As locking member 24 moves downward, spring 72 rotates release actuator 70 clockwise so that locking member 24 is vertically restrained by lower leg 76. With locking member 24 restrained in the downward position by leg 76, cargo holder 30 may be pivoted from release position 36 downward to stowed position 32 with slot 54 traveling over locking member 24. As hubs 50 rotate clockwise to stowed position 32, slide portion 60 of tab 58 slides beneath the stationary tang 80 of release actuator 70 to permit hubs 50 to rotate fully to stowed position 32. When cargo holder 30 is moved from stowed position 32 to usage position 34, hubs 50 rotate counterclockwise with locking member 24 traveling through slot 54 toward locking recess 56. As locking recess 56 aligns over locking member 24, face portion 62 of tab 58 contacts tang 80 and rotates release actuator 70 counterclockwise until upper leg 78 coincides with locking recess 56 and spring 26 biases locking member 24 into locking recess 56.

In an alternative embodiment, one or both sides of the front end of cargo holder may be provided with holders (e.g. brackets, latches, projections, etc.) adapted to releasably engage corresponding features on a side panel or other portion of the vehicle interior for supporting the front end of the cargo holder in the usage position. In another alternative embodiment, a folding leg may be hingably connected to the underside of the cargo holder near the front end and adapted to engage the floor of the vehicle to provide additional support to cargo holder when in the usage position. In a further alternative embodiment, one or more hingable braces may be provided having a first end pivotally connected to the underside of the cargo holder and a second end pivotally coupled to the support member beneath the hub. The braces may be similar to conventional braces such as are used on the legs of folding tables where the brace may be locked in an open position to support cargo member and may be folded at a hinge to allow the cargo member to pivot to the stowed position. Braces may also be provided with an over-center spring device having a center point for urging the braces into an open position when the cargo holder is moved in an upward direction beyond the centering point, and for urging the braces into a closed position when moving the cargo holder in a downward direction beyond the center point. In a further alternative embodiment, the braces may configured in a four-bar linkage configuration as shown in U.S. patent application Ser. No. ______ titled “Load Floor System” filed on Dec. 7, 2001 (Attorney Docket No. 026032-3872) which is incorporated herein by reference. In further alternative embodiments, the braces may be any conventional folding bracket device such as the KV206 Folding L-Bracket manufactured by Knape & Vogt of Grand Rapids, Mich.; or the Numa-Lift2™ mechanism or Genu-Fold3™ device, both manufactured by Valley Design.

According to a preferred embodiment, system 10 may be removed as a single unit or as individual components from a vehicle. System 10 may be removed as a single unit by releasing connectors 17 and 19 at the top and bottom of support members 12 as necessary, retracting the telescoping portions of support members 12 as necessary, and moving cargo holder 30 to the stowed position 32. System 10 may also be removed partially or completely removed from a vehicle as individual components. For example, cargo holder 30 may be detached from support members 12 by removing couplers 28, and removed individually or along with one or more of support members 12. Alternatively, cargo holder 30 may be removed and other objects or devices may be attached or mounted to support members 12. The system 10 or any of its components may be stored flat within the vehicle or may be stored externally from a vehicle until it is desired to be reinstalled within the vehicle by engaging the connector 19 to structure in the vehicle floor portion, extending the telescoping portions of support members 12 to the extent necessary to engage connector 19 with the overhead structure, such as rails or brackets, within the vehicle.

According to any preferred embodiment, system 10 is capable of removably and interchangeably receiving and supporting a wide variety of articles for use within or in conjunction with a vehicle. Such articles may include commercial, industrial or consumer-oriented cargo or articles, including, but not limited to: storage compartments; auxiliary mounting structures such as handles, brackets, fixtures for direct or indirect-mounting capability for racks, cages, or support pillars for optionally mounting additional articles such as portable shelving or carriers in a cargo area; lighting equipment, power adapters and outlets; media devices such as visual display screens, audio equipment, media displays, digital video disc players, GPS receivers; utility devices such as cargo storage racks, cargo netting and holders, straps or tie-downs, garment hangers, rods or racks; insulated hot or cold-storage containers; mobile office workstation components; tools or equipment such as portable air compressors or vacuum cleaners; occupant safety devices; specially-adapted consumer-use products such as travel tables, camping gear, pet barriers, luggage, etc.; brackets having rigid, swiveling or rotating couplers for removably receiving these or other such articles; storage racks having fixed or retractable support members for storing skis or other gear; and any other articles which may be useful in conjunction with traveling, working or other use of a vehicle.

In other alternative embodiments, support members may have electrically conductive or utility-carrying portions provided to deliver electrical power or data or communication signals to one or more electrical items stored on, or mounted to, the cargo holder. In order to provide an interface between the support members and the cargo items, the support member may include electrically conductive portions such as a conductor or metallic strip adapted to engage a cargo item on one end and operably engages a source of vehicle power through either or both of the connectors coupled to the support members.

It is important to note that the construction and arrangement of the elements of the storage system for a vehicle provided herein are illustrative only. Although only a few exemplary embodiments of the present invention have been described in detail in this disclosure, those skilled in the art who review this disclosure will readily appreciate that many modifications are possible in these embodiments (such as variations in installation location and orientation within a vehicle, sizes, structures, shapes and proportions of the various elements, mounting arrangements, configuration and operation of biasing devices, operation of locking and support devices, arrangement of utility-carrying conductors, operation of height adjustment devices, use of materials, colors, combinations of shapes, etc.) without materially departing from the novel teachings and advantages of the invention. For example, the system may be used in the interior of any vehicle (such as an automobile, truck, sport utility vehicle, van, boat, airplane, train, construction or farming equipment, tractor trailer trucks, motor homes and recreational vehicles, etc.). According to other alternative embodiments, the storage system may be connected to any suitable structure within a vehicle such as floor and overhead receptacles, seating components, interior side or door panels, cargo storage area components, etc. According to further alternative embodiments, the positioner interface may have an adjustable width for accommodating various lateral spacing options for the support members. Further, it is readily apparent that variations of the system may be provided in a wide variety of shapes, sizes, spatial orientations, and engagement profiles and adapted for installation within any suitable portion of a vehicle, or within a cargo area or other suitable location within a vehicle. It is also readily apparent that the system may be designed with any connector device suitable for releasably attaching to a portion of the vehicle. Accordingly, all such modifications are intended to be within the scope of the invention as defined in the appended claims.

What is claimed is:

1. A storage system for a vehicle, comprising:
at least one support member adapted to couple to the vehicle;
a cargo device coupled to the support member; and
an adjustment device operably engaging the support member and the cargo device, the adjustment device operable to configure the cargo device in at least one position.

2. The storage system of claim 1, wherein the support member is an elongated member having a first end and a second end adapted for coupling to the vehicle.

3. The storage system of claim 2, wherein the support member is two or more elongated members in telescoping relation for selective extension and retraction.

4. The storage system of claim 2, wherein the first end of the support member includes a first quick-release connector adapted to couple the support member to the vehicle.

5. The storage system of claim 4, wherein the first quick-release connector is adapted to couple the support member to a rail member positioned along one or more of an overhead portion, a floor portion or a side panel of the vehicle.

6. The storage system of claim 2, wherein the second end of the support member includes a second quick-release connector adapted to couple the support member to the vehicle in a removable manner.

7. The storage system of claim 6, wherein the second quickrelease connector is adapted to couple the support member to a receiving mechanism in one or more of an overhead portion, a floor, or a side panel of the vehicle.

8. The storage system of claim 1, wherein the cargo device is selectively deployable between the usage position and the stowed position.

9. The storage system of claim 1, wherein the cargo device is a tray having a peripheral ledge for retaining one or more articles of cargo and a handle for positioning the cargo device.

10. The storage system of claim 9, wherein the tray is formed from a mesh material.

11. The storage system of claim 9, wherein the tray further comprises a selectively deployable support leg having a first end coupled to the tray and a second end adapted to engage a floor of the vehicle to support the tray.

12. The storage system of claim 9, wherein the tray further comprises one or more brackets adapted to engage a side portion of the vehicle when the cargo device is in the usage position.

13. The storage system of claim 1, wherein the cargo device includes one or more cargo management devices.

14. The storage system of claim 13, wherein the cargo management devices are one or more of a recess, a latch, a holder, a net, a hook, a divider, a basket, a tie-down, a strap and a compartment.

15. The storage system of claim 1, wherein the adjustment device further comprises one or more arms coupled to an underside of the cargo device.

16. The storage system of claim 15, wherein the arms include a hub portion rotatably coupled to the support member.

17. The storage system of claim 16, wherein the hub portion includes a lock device engageable when the cargo device is moved to the usage position, and releasable when the cargo device is moved away from the usage position.

18. The storage system of claim 15, wherein the arms are hingeable and coupled to the support member.

19. The storage system of claim 18, wherein the arms include a spring-biased over-center device having a center point and configured to bias the arms in the usage position when the cargo device is moved in a first direction beyond the center point and to bias the arms in the stowed position when the cargo device is moved in a second direction beyond the center point.

20. The storage system of claim 1, wherein the support member, the cargo device and the adjustment device are selectively removable as a unit from the vehicle.

21. The storage system of claim 1, wherein the support member is oriented in a generally vertical position.

22. The storage system of claim 21, wherein the cargo device is adjustable in a vertical direction and fixable at a plurality of heights relative to the vehicle.

23. The storage system of claim 1, wherein the support member includes an electrical conductor for transferring electrical power to at least one article.

24. The storage system of claim 23, wherein the article is a light coupled to the support member.

25. The storage system of claim 23, wherein the article is cargo.

26. The storage system of claim 1, wherein the support member is adapted to be coupled to a rear seat in the vehicle.

27. A cargo management system for a vehicle, comprising:
means for coupling at least one support column to the interior of the vehicle;
means for coupling a cargo holder to the support column; and
means for alternatively positioning the cargo holder in a usage position and a stowed position.

28. The cargo management system of claim 27, further comprising means for releasably locking the cargo holder in the usage position.

29. The cargo management system of claim 27, further comprising means for selectively adjusting the height of the cargo holder relative to the support members.

30. The cargo management system of claim 27 further comprising means for communicating electrical power to articles on the cargo holder.

31. A kit for a storage system in a vehicle, the kit comprising:
at least one support member adapted to be coupled to the vehicle;
a cargo holder adapted to be coupled to the support member; and
a locking device adapted to releasably lock the cargo holder in a cargo storage position relative to the support member.

32. The kit of claim 31, further comprising a positioner interface adapted to be coupled to the cargo holder and to the support member.

33. The kit of claim 31, further comprising at least one attachment device adapted to couple the support member to the vehicle.

34. The kit of claim 31, further comprising an adjustment device adapted to adjust the height of the cargo holder relative to the support member.

35. The kit of claim 31, further comprising an electrical interface adapted to provide power from the vehicle to the cargo holder.

36. A method for providing a cargo storage system in a vehicle, comprising:
coupling at least one support member to the vehicle;
coupling a cargo holder to the support member; and
providing a lockable positioning interface operably engaging the support member and the cargo holder for selectively positioning the cargo holder in a use position and a stowed position.

37. The method of claim 36, further comprising the step of providing at least one attachment device adapted to couple the support member to the vehicle.

38. The method of claim 36, further comprising the step of providing an adjustment device adapted to adjust the height of the cargo holder.
